(19) United States
(12) Patent Application Publication
(10) Pub. No.: US 2025/0015413 A1
(43) Pub. Date: Jan. 9, 2025

(54) BATTERY PACK

(71) Applicant: MURATA MANUFACTURING CO., LTD., Kyoto (JP)

(72) Inventor: Yoshiyuki BANNAI, Kyoto (JP)

(21) Appl. No.: 18/625,981

(22) Filed: Apr. 3, 2024

(30) Foreign Application Priority Data
Jul. 4, 2023 (JP) 2023-110004

(51) Int. Cl. H01M 50/242; H01M 10/48; H01M 50/213; H01M 50/244; H01M 50/284

(52) U.S. Cl. CPC H01M 50/242; H01M 10/482; H01M 50/213; H01M 50/244; H01M 50/284

(57) ABSTRACT

Provided is a battery pack capable of improving impact resistance without complicating the structure. A battery pack according to an embodiment of the present technology includes a battery module including a battery and a battery holder that holds the battery, and a battery case that houses the battery module. The battery module has a first outer surface and a second outer surface facing the first outer surface. The battery case has a first inner surface disposed facing the first outer surface and warped toward the first outer surface, and a second inner surface disposed facing the second outer surface and warped toward the second outer surface. The battery module is supported on the first inner surface and the second inner surface by warpage of the first inner surface and warpage of the second inner surface.

### CROSS REFERENCE TO RELATED APPLICATIONS

The present application claim priority to Japanese patent application no. 2023-110004, filed on Jul. 4, 2023, the entire contents of which are incorporate herein by reference.

### BACKGROUND

The present technology relates to a battery pack.

Since electronic equipment has been widely spread, a battery has been developed as a power source applied to the electronic equipment. In this case, in order to handle a plurality of batteries easily and safely, a battery pack including the plurality of batteries has been proposed.

Various studies have been made on the technology related to the configuration of the battery pack. For example, a technique of providing an elastic spring between an exterior case and a battery module housing a plurality of batteries in order to improve impact resistance is provided.

### SUMMARY

The present technology relates to a battery pack.

However, in the technique described in the Background section, since the elastic spring is provided integrally with the exterior case or the battery module, a mold structure for molding the exterior case or the battery module becomes complicated. It is desirable to provide a battery pack capable of improving impact resistance without complicating the structure.

A battery pack according to an embodiment of the present technology includes a battery module including a battery and a battery holder that holds the battery, and a battery case that houses the battery module. The battery module has a first outer surface and a second outer surface facing the first outer surface. The battery case has a first inner surface disposed facing the first outer surface and warped toward the first outer surface, and a second inner surface disposed facing the second outer surface and warped toward the second outer surface. The battery module is supported on the first inner surface and the second inner surface by warpage of the first inner surface and warpage of the second inner surface.

In the battery pack according to an embodiment of the present technology, the battery module is supported by the first and second inner surfaces by warpage of the first and second inner surfaces provided in the battery case. As a result, when a large impact such as falling is applied to the battery pack, the impact is alleviated or absorbed by warpage of at least one of the first and second inner surfaces. As a result, the battery module can be protected from the impact. By the way, in this battery pack, a large impact such as falling is alleviated or absorbed by warpage of the first and second inner surfaces. As described above, in this battery pack, instead of providing a new component such as an elastic spring, the inner surface of the existing battery case has a function of alleviating or absorbing buffer. In addition, the inner surface of the existing battery case is just warped, and a complicated structure is not provided. Therefore, impact resistance can be improved without complicating the structure.

### BRIEF DESCRIPTION OF THE FIGURES

FIG. 1 is a perspective view showing a perspective configuration example of a battery pack according to an embodiment of the present technology;

FIG. 2 is a view showing a perspective configuration example of a housed object of the battery pack of FIG. 1;

FIG. 3 is a view showing a developed perspective configuration example of the battery pack of FIG. 1;

FIG. 4 is a view showing a sectional configuration example of a battery holder of FIG. 2;

FIG. 5 is a view showing a sectional configuration example of the battery pack of FIG. 1 in a direction of arrows A-A;

FIG. 6 is a view showing a sectional configuration example of the battery pack of FIG. 1 in a direction of arrows B-B;

FIG. 7 is a view showing a sectional configuration example in the direction of arrows A-A when a battery module is removed from the battery pack of FIG. 1;

FIG. 8 is a view showing a sectional configuration example in the direction of arrows B-B when the battery module is removed from the battery pack of FIG. 1;

FIG. 9 is a view showing a sectional configuration example of the battery pack of FIG. 1 in a direction of arrows C-C;

FIG. 10 is a view showing a sectional configuration example of the battery pack of FIG. 1 in a direction of arrows D-D;

FIG. 11 is a view showing a perspective configuration example of a lower case of FIG. 1;

FIG. 12 is a view showing a perspective configuration example of an upper case of FIG. 1;

FIG. 13 is a view for explaining a function of the exterior case of FIG. 1 when the battery pack of FIG. 1 falls on the ground;

FIG. 14 is a view showing a modification of the sectional configuration example of FIG. 5;

FIG. 15 is a view showing a modification of the sectional configuration example of FIG. 6;

FIG. 16 is a view showing a modification of the sectional configuration example of FIG. 5;

FIG. 17 is a view showing a modification of the sectional configuration example of FIG. 6;

FIG. 18 is a view showing a modification of a perspective configuration of the battery pack of FIG. 1;

FIG. 19 is a view showing a developed perspective configuration example of the battery pack of FIG. 18;

FIG. 20 is a view showing a planar configuration example of an inner top surface side of the upper case of FIG. 19; and

FIG. 21 is a view showing a modification of the sectional configuration example of FIG. 5.

### DETAILED DESCRIPTION

Hereinafter, the present technology will be described in further detail including with reference to the drawings according to an embodiment.

First, a battery pack 1 according to an embodiment of the present technology is described.

The battery pack 1 described here is a power supply including a plurality of batteries, and is applied to various applications such as electronic devices. Details of the application of the battery pack 1 will be described later. The kind of the battery is not particularly limited, and may be a primary battery or a secondary battery. The kind of the secondary battery is not particularly limited, and is specifically a lithium ion secondary battery or the like in which a battery capacity is obtained using occlusion and release of lithium ions. The number of batteries is not particularly limited, and thus can be set arbitrarily. Hereinafter, a case where the battery is a secondary battery (lithium ion secondary battery) will be described. That is, the battery pack 1 described below is a power supply including a plurality of secondary batteries.

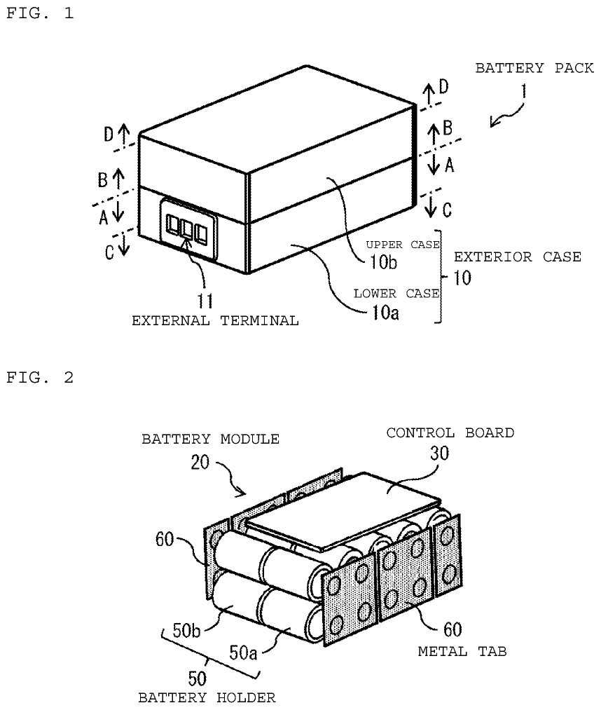

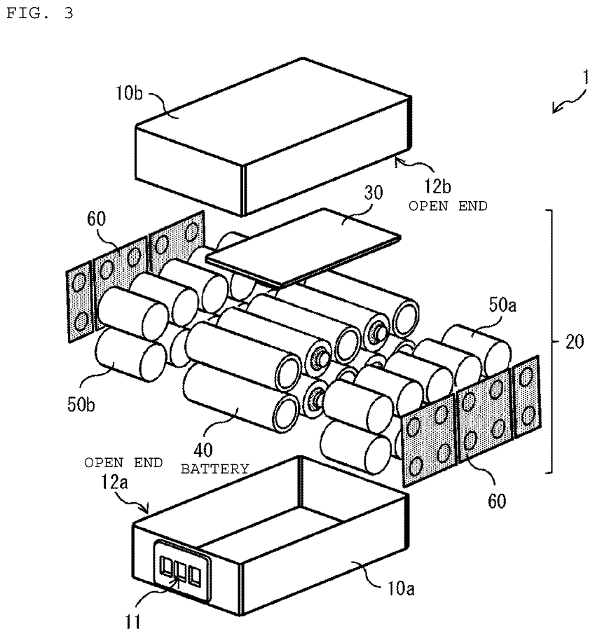

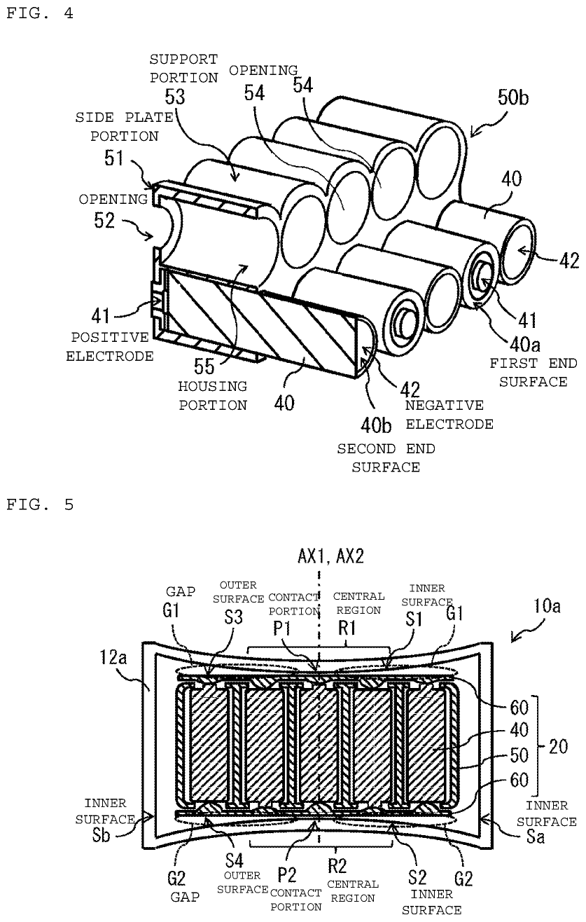

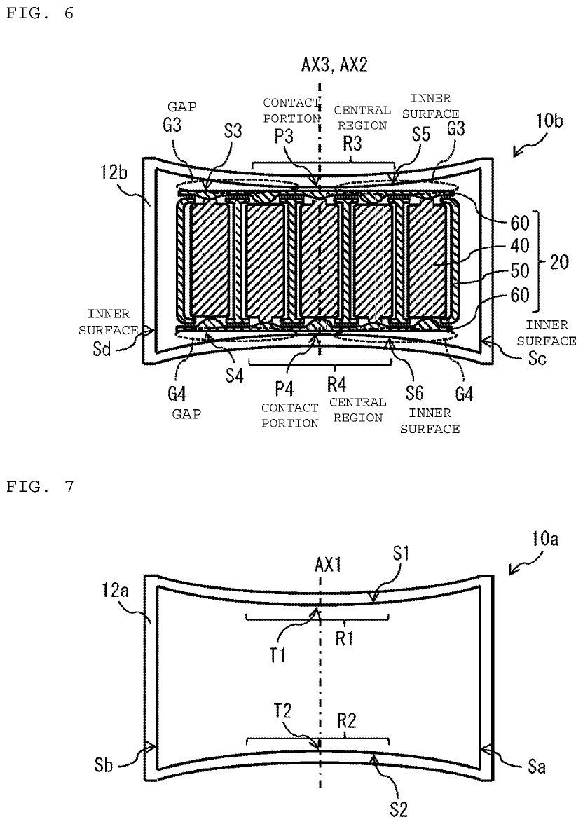

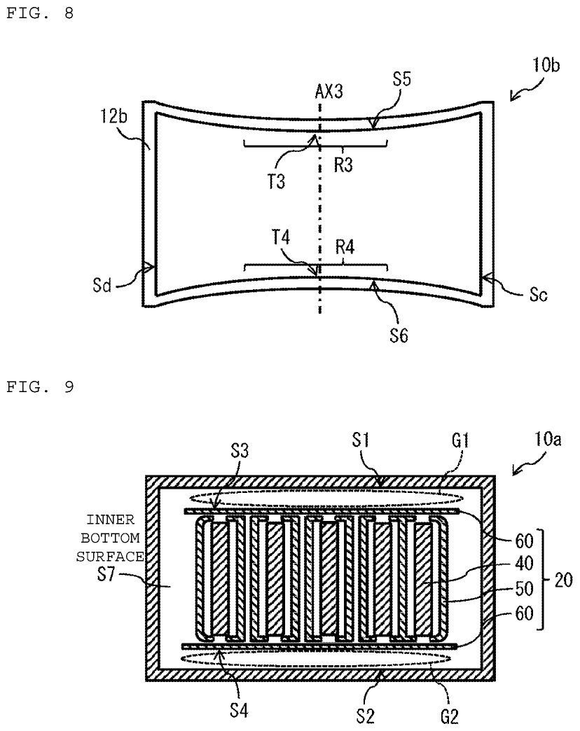

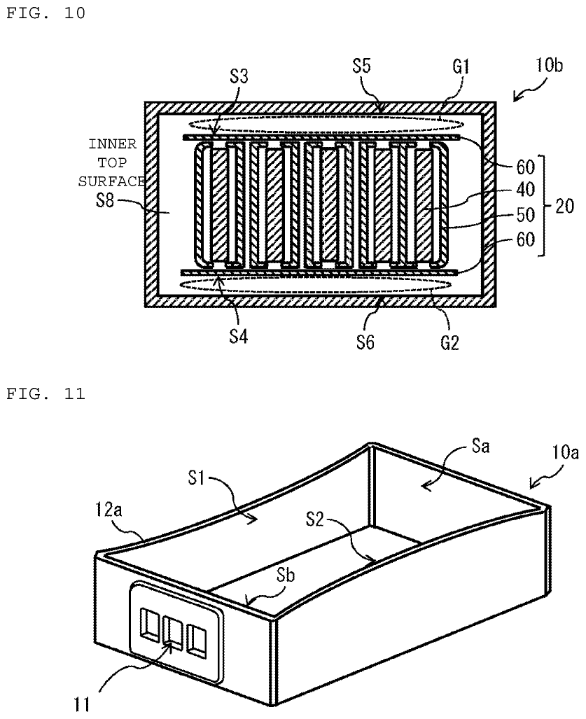

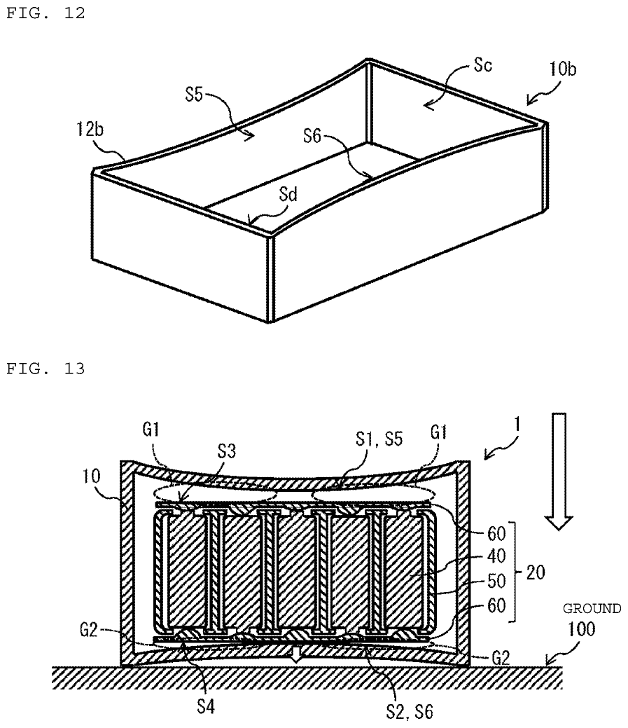

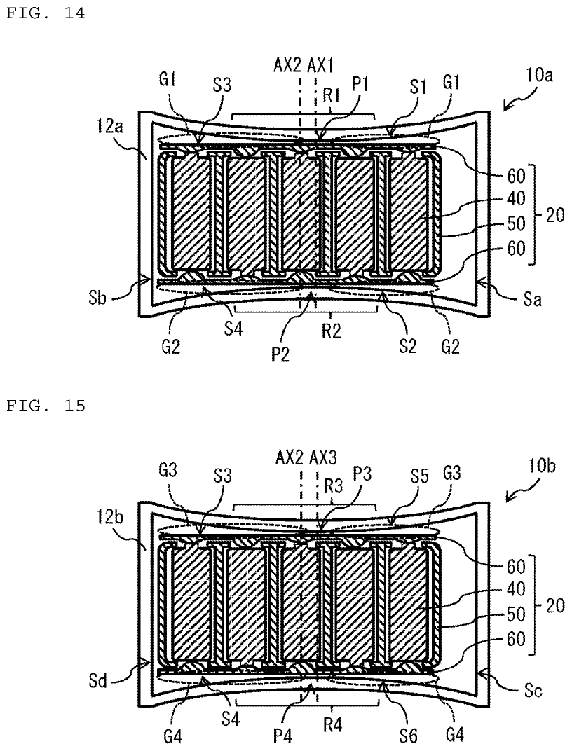

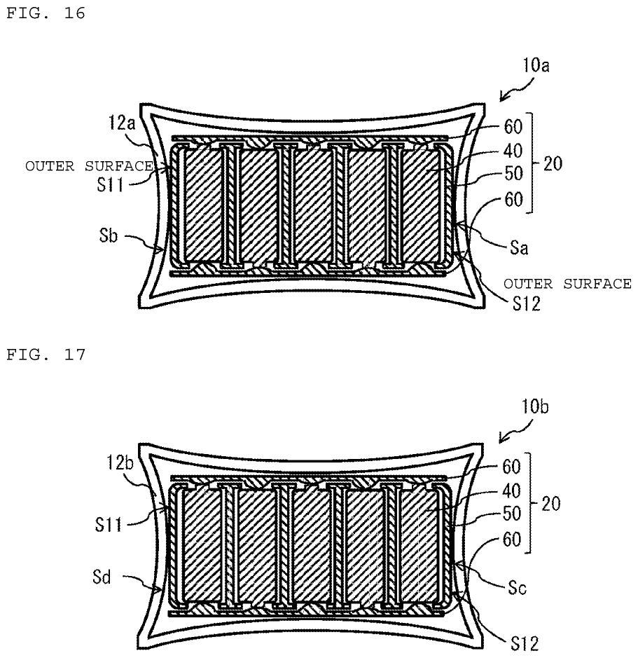

FIG. 1 shows a perspective configuration example of a battery pack 1 according to an embodiment of the present technology. FIG. 2 shows a perspective configuration example of the housed object of the battery pack 1. FIG. 3 shows a developed perspective configuration example of the battery pack 1.

For example, as shown in FIGS. 1 and 2, the battery pack 1 includes an exterior case 10 and a battery module 20 housed in the exterior case 10. The battery module 20 includes a control board 30. The control board 30 is connected to, for example, positive and negative electrode terminals of each battery 40 to be described later, and includes a circuit that measures the voltage of each battery 40, detects the remaining capacity of each battery 40, measures the current output from each battery 40 to detect the presence or absence of an overcurrent, and the like.

The exterior case 10 includes, for example, a lower case 10a and an upper case 10b as shown in FIG. 3. An open end 12a of the lower case 10a and an open end 12b of the upper case 10b are butt-joined against each other, thereby forming a housing space for housing the battery module 20. FIG. 3 shows an example in which a housing space for housing the battery module 20 is formed by a space surrounded by the lower case 10a and a space surrounded by the upper case 10b.

The exterior case 10 has a shape capable of housing the battery module 20. An external terminal 11 connected to the control board 30 is provided in the exterior case 10 (for example, lower case 10a). The plurality of batteries 40 is connected to the external terminal 11 via the control board 30.

The exterior case 10 includes a resin material such as polyethylene (PE), polypropylene (PP), polycarbonate (PC), modified polyphenylene ether (mPPE), polyamide (PA), polybutylene terephthalate (PBT), a copolymer synthetic resin of acrylonitrile-butadiene-styrene (ABS), or polyacetal (POM). The exterior case 10 may include, for example, metal or a resin material in which a conductive material such as a conductive filler is dispersed. The resin material at this time may be the above-described resin material.

The battery module 20 includes a plurality of batteries 40 and a plurality of metal tabs 60. The plurality of batteries 40 is electrically connected via a plurality of metal tabs 60. For example, the plurality of batteries 40, which are some of the plurality of batteries 40, are connected in series to each other by the plurality of metal tabs 60, and when the plurality of batteries 40 connected in series to each other is referred to as a series unit, the plurality of series units are connected in parallel to each other by the plurality of metal tabs 60. The connection mode of the plurality of batteries 40 is not limited to the above. Each of the metal tabs 60 includes, for example, a metal lead plate.

For example, as shown in FIG. 4, the battery 40 includes a first end surface 40a and a second end surface 40b facing each other, a positive electrode 41 provided on the first end surface 40a, and a negative electrode 42 provided on the second end surface 40b. FIG. 4 shows a sectional configuration example of the plurality of batteries 40 and a battery holder 50 that supports the plurality of batteries 40. The battery 40 has, for example, a columnar shape in which the first end surface 40a and the second end surface 40b extend in directions facing each other, and each of the first end surface 40a and the second end surface 40b has a circular shape. The shape of the battery 40 is not limited to a columnar shape. The shapes of the first end surface 40a and the second end surface 40b are not limited to the circular shape.

The positive electrode 41 includes a metal member. The positive electrode 41 has a projecting shape on the first end surface 40a. The negative electrode 42 includes a metal member. The negative electrode 42 forms a flat surface on the second end surface 40b.

It is assumed that the plurality of batteries 40 are arranged side by side in a two-dimensional direction orthogonal to a longitudinal direction of the battery 40 (direction in which the positive electrode 41 and the negative electrode 42 face each other in the battery 40). At this time, the first end surface 40a of one battery 40 (first battery) in the plurality of batteries 40 provided in the battery pack 1 and the second end surface 40b of another battery 40 (second battery) in the plurality of batteries 40 provided in the battery pack 1 are arranged in the same plane. For example, a plurality of the first end surfaces 40a and a plurality of the second end surfaces 40b are alternately arranged in the same plane. The plurality of metal tabs 60 are arranged in a manner of facing each other with the plurality of batteries 40, provided in the battery pack 1, sandwiched in the longitudinal direction of the batteries 40. The metal tab 60 is electrically connected to the positive electrode 41 on the first end surface 40a of the first battery and to the negative electrode 42 on the second end surface 40b of the second battery.

In the present description, the “longitudinal direction of the batteries 40” is a direction parallel to a direction in which the positive electrode 41 and the negative electrode 42 face each other in a case where the batteries 40 have a columnar shape extending in a direction in which the positive electrode 41 and the negative electrode 42 face each other. In the present description, the “arrangement direction of the batteries 40” is a direction orthogonal to the direction in which the positive electrode 41 and the negative electrode 42 face each other in the case where the batteries 40 have a columnar shape extending in the direction in which the positive electrode 41 and the negative electrode 42 face each other.

The battery module 20 further includes the battery holder 50 capable of supporting the plurality of batteries 40. As shown in FIGS. 3 and 4, for example, the battery holder 50 includes a pair of holder 50a and holder 50b. The holders 50a and 50b both have a common structure. FIG. 4 shows a sectional configuration example of the holder 50b.

Each of the holders 50a and 50b has a side plate portion 51, for example, as shown in FIG. 4. The side plate portion 51 of the holder 50a and the side plate portion 51 of the holder 50b are arranged to face each other in the longitudinal direction of each of the batteries 40. In the holders 50a and 50b, the side plate portion 51 has an opening 52 at a position facing the positive electrode 41 and the negative electrode 42 of each of the batteries 40. Therefore, the positive electrode 41 or the negative electrode 42 is exposed in the opening 52.

Each of the holders 50a, 50b includes a support portion 53 that supports the plurality of batteries 40 in a hierarchical manner with a predetermined gap interposed therebetween as shown in FIG. 4. FIG. 4 shows a state in which the support portion 53 is provided in a manner of supporting the plurality of batteries 40 in two layers of the lowermost layer and the uppermost layer. The lowermost layer is a layer that is the lowermost when the battery pack 1 (battery module 20) is viewed from a direction oriented in the direction of FIG. 4. The uppermost layer is a layer that is the uppermost when the battery pack 1 (battery module 20) is viewed from a direction oriented in the direction of FIG. 4.

The side plate portion 51 is coupled to one end portion of the support portion 53, and the other end portion of the support portion 53 is an opening 54. The support portion 53 is provided with a housing portion 55 coupled to the opening 52 and the opening 54. A part of the battery 40 is housed in the housing portion 55.

FIG. 5 shows a sectional configuration example of the battery pack 1 of FIG. 1 in a direction of arrows A-A. FIG. 6 shows a sectional configuration example of the battery pack 1 of FIG. 1 in a direction of arrows B-B. FIG. 7 shows a sectional configuration example in the direction of arrows A-A when the battery module 20 is removed from the battery pack 1 of FIG. 1. FIG. 8 shows a sectional configuration example in the direction of arrows B-B when the battery module 20 is removed from the battery pack 1 of FIG. 1. FIG. 9 shows a sectional configuration example of the battery pack 1 of FIG. 1 in a direction of arrows C-C. FIG. 10 shows a sectional configuration example of the battery pack 1 of FIG. 1 in a direction of arrows D-D. FIG. 11 shows a perspective configuration example of the lower case 10a of FIG. 1. FIG. 12 shows a perspective configuration example of the upper case 10b of FIG. 1.

In the battery module 20, a length in a direction parallel to one arrangement direction of the battery 40 (for example, a lateral direction of the battery 40 in FIG. 5) is longer than a length in a direction parallel to the longitudinal direction of the battery 40. Hereinafter, the direction parallel to one arrangement direction of the battery 40 (for example, the lateral direction of the battery 40 in FIG. 5) is referred to as a “longitudinal direction of the battery module 20”. The direction parallel to the longitudinal direction of the battery 40 is referred to as a “lateral direction of the battery module 20”. The battery module 20 is provided with a pair of outer surfaces S3 and S4 extending in the direction (the longitudinal direction of the battery module 20) parallel to one arrangement direction of the battery 40 (for example, the lateral direction of the battery 40 in FIG. 5). The outer surface S3 corresponds to, for example, the surfaces of the plurality of metal tabs 60 arranged in the same plane. The outer surface S4 corresponds to, for example, the surfaces of the plurality of metal tabs 60 arranged in the same plane at a position facing the outer surface S3 via the plurality of batteries 40.

In the lower case 10a, a length in the direction parallel to the longitudinal direction of the battery module 20 is longer than a length in a direction parallel to the lateral direction of the battery module 20. The lower case 10a is provided with a pair of inner surfaces S1 and S2 extending in the direction parallel to the longitudinal direction of the battery module 20 (longitudinal direction of the lower case 10a). The inner surfaces S1 and S2 are arranged so as to sandwich the plurality of batteries 40 from the longitudinal direction of the battery 40. The lower case 10a is further provided with a pair of inner surfaces Sa and Sb extending in the direction parallel to the lateral direction of the battery module 20 (lateral direction of the lower case 10a). The inner surface S1 is in contact with the inner surfaces Sa and Sb at a corner of the lower case 10a. The inner surface S2 is in contact with the inner surfaces Sa and Sb at a corner of the lower case 10a.

The inner surface S1 is provided at a position facing a part of the outer surface S3, and warped toward the outer surface S3 (inside the lower case 10a). The portion of the inner surface S1 warped toward the outer surface S3 (inside the lower case 10a) includes a part of the open end 12a, for example, as shown in FIGS. 5, 7, and 11. That is, warpage protruding toward the outer surface S3 (inside the lower case 10a) is formed at the open end 12a. On the inner surface S1, for example, not only in a state where the battery module 20 is housed in the lower case 10a as shown in FIG. 5, but also in a state where the battery module 20 is removed from the lower case 10a as shown in FIGS. 7 and 11, for example, a warpage is formed protruding toward the outer surface S3 (inside the lower case 10a).

The inner surface S2 is provided at a position facing a part of the outer surface S4, and warped toward the outer surface S4 (inside the lower case 10a). The portion of the inner surface S2 warped toward the outer surface S4 (inside the lower case 10a) includes a part of the open end 12a, for example, as shown in FIGS. 5, 7, and 11. That is, warpage protruding toward the outer surface S4 (inside the lower case 10a) is formed at the open end 12a. On the inner surface S2, for example, not only in a state where the battery module 20 is housed in the lower case 10a as shown in FIG. 5, but also in a state where the battery module 20 is removed from the lower case 10a as shown in FIGS. 7 and 11, for example, a warpage is formed protruding toward the outer surface S4 (inside the lower case 10a). Therefore, for example, as shown in FIG. 5, the battery module 20 is supported (sandwiched) by the inner surface S1 and the inner surface S2 by the warpage of the inner surface S1 and the warpage of the inner surface S2. The warpage of the inner surface S1 and the warpage of the inner surface S2 can be formed, for example, by generating contraction stress by temperature control at the time of resin molding of the lower case 10a.

In the upper case 10b, the length in the direction parallel to the longitudinal direction of the battery module 20 is longer than the length in the direction parallel to the lateral direction of the battery module 20. The upper case 10b is provided with a pair of inner surfaces S5 and S6 extending in the direction parallel to the longitudinal direction of the battery module 20 (longitudinal direction of the upper case 10b). The inner surfaces S5 and S6 are arranged so as to sandwich the plurality of batteries 40 from the longitudinal direction of the battery 40. The upper case 10b is further provided with a pair of inner surfaces Sc and Sd extending in the direction parallel to the lateral direction of the battery module 20 (lateral direction of the upper case 10b). The inner surface S5 is in contact with the inner surfaces Sc and Sd at a corner of the upper case 10b. The inner surface S6 is in contact with the inner surfaces Sc and Sd at a corner of the upper case 10b.

The inner surface S5 is provided at a position facing a part of the outer surface S3, and warped toward the outer surface S3 (inside the upper case 10b). The portion of the inner surface S5 warped toward the outer surface S3 (inside the upper case 10b) includes the open end 12b, for example, as shown in FIGS. 5, 7, and 11. That is, warpage protruding toward the outer surface S3 (inside the upper case 10b) is formed at the open end 12b. On the inner surface S5, for example, not only in a state where the battery module 20 is housed in the upper case 10b as shown in FIG. 5, but also in a state where the battery module 20 is removed from the upper case 10b as shown in FIGS. 7 and 11, for example, a warpage is formed protruding toward the outer surface S3 (inside the upper case 10b).

The inner surface S6 is provided at a position facing a part of the outer surface S4, and warped toward the outer surface S4 (inside the upper case 10b). The portion of the inner surface S6 warped toward the outer surface S4 (inside the upper case 10b) includes the open end 12b, for example, as shown in FIGS. 5, 7, and 11. That is, a warpage protruding toward the outer surface S4 (inside the upper case 10b) is formed at the open end 12b. On the inner surface S6, for example, not only in a state where the battery module 20 is housed in the upper case 10b as shown in FIG. 5, but also in a state where the battery module 20 is removed from the upper case 10b as shown in FIGS. 7 and 11, for example, a warpage is formed protruding toward the outer surface S4 (inside the upper case 10b). Therefore, for example, as shown in FIG. 5, the battery module 20 is supported (sandwiched) by the inner surface S5 and the inner surface S6 by the warpage of the inner surface S5 and the warpage of the inner surface S6. The warpage of the inner surface S5 and the warpage of the inner surface S6 can be formed, for example, by generating contraction stress by temperature control at the time of resin molding of the upper case 10b.

The inner surface S1 and the outer surface S3 are in contact with each other by predetermined pressing due to warpage of the inner surface S1, and a gap G1 in which the inner surface S1 and the outer surface S3 space away from each other is formed around a contact portion P1 between the inner surface S1 and the outer surface S3. The contact portion P1 is provided, for example, at the open end 12a. The inner surface S2 and the outer surface S4 are in contact with each other by predetermined pressing due to warpage of the inner surface S2, and a gap G2 in which the inner surface S2 and the outer surface S4 space away from each other is formed around a contact portion P2 between the inner surface S2 and the outer surface S4. The contact portion P2 is provided, for example, at the open end 12a.

The inner surface S5 and the outer surface S3 are in contact with each other by predetermined pressing due to warpage of the inner surface S5, and a gap G3 in which the inner surface S5 and the outer surface S3 space away from each other is formed around a contact portion P3 between the inner surface S5 and the outer surface S3. The contact portion P3 is provided, for example, at the open end 12b. The inner surface S6 and the outer surface S4 are in contact with each other by predetermined pressing due to warpage of the inner surface S6, and a gap G4 in which the inner surface S5 and the outer surface S4 space away from each other is formed around a contact portion P4 between the inner surface S6 and the outer surface S4. The contact portion P4 is provided, for example, at the open end 12b.

The contact portion P1 between the inner surface S1 and the outer surface S3 is disposed in a central region R1 of the inner surface S1 excluding both ends of the inner surface S1 when the open end 12a is viewed in plan view. For example, as shown in FIG. 5, the central region R1 is a region facing the center battery 40 in the arrangement direction of the battery 40 and the two batteries 40 (that is, a total of three batteries 40) on both sides of the center battery 40 of the plurality of batteries 40 included in the battery module 20 when the open end 12a is viewed in plan view. For example, as shown in FIG. 5, the contact portion P1 is disposed at a position on a center line AX1 connecting a center portion of the inner surface S1 and a center portion of the inner surface S2 when the open end 12a is viewed in plan view. For example, as shown in FIG. 5, the contact portion P1 is disposed at a position on the center line AX1 of the battery module 20. In addition, for example, as shown in FIG. 5, the contact portion P1 is disposed at a center portion (a position on a center line AX2) of the battery module 20 in the longitudinal direction of the battery module 20 when the open end 12a is viewed in plan view. For example, the contact portion P1 is disposed at a center portion (a position on the center line AX2) of the outer surface S3 of the battery module 20 when the open end 12a is viewed in plan view. For example, as shown in FIG. 5, the center line AX1 and the center line AX2 may coincide with each other.

The center portion of the inner surface S1 when the open end 12a is viewed in plan view is located at a position equidistant from both ends of the inner surface S1 when the open end 12a is viewed in plan view. The center portion of the inner surface S2 when the open end 12a is viewed in plan view is located at a position equidistant from both ends of the inner surface S2 when the open end 12a is viewed in plan view. The center portion of the battery module 20 in the longitudinal direction of the battery module 20 when the open end 12a is viewed in plan view is located at a position equidistant from both ends of the battery module 20 in the longitudinal direction of the battery module 20 when the open end 12a is viewed in plan view.

The contact portion P2 between the inner surface S2 and the outer surface S4 is disposed in a central region R2 of the inner surface S2 excluding both ends of the inner surface S2 when the open end 12a is viewed in plan view. For example, as shown in FIG. 5, the central region R2 is a region facing the center battery 40 in the arrangement direction of the battery 40 and the two batteries 40 (that is, a total of three batteries 40) on both sides of the center battery 40 of the plurality of batteries 40 included in the battery module 20 when the open end 12a is viewed in plan view. For example, as shown in FIG. 5, the contact portion P2 is disposed at the position on the center line AX1 when the open end 12a is viewed in plan view. In addition, for example, as shown in FIG. 5, the contact portion P2 is disposed at the center portion (the position on the center line AX2) in the longitudinal direction of the battery module 20 when the open end 12a is viewed in plan view. For example, the contact portion P2 is disposed on the center portion (the position on the center line AX2) of the outer surface S4 of the battery module 20 when the open end 12a is viewed in plan view.

The contact portion P3 between the inner surface S5 and the outer surface S3 is disposed in a central region R3 of the inner surface S5 excluding both ends of the inner surface S5 when the open end 12b is viewed in plan view. For example, as shown in FIG. 6, the central region R3 is a region facing the center battery 40 in the arrangement direction of the battery 40 and the two batteries 40 (that is, a total of three batteries 40) on both sides of the center battery 40 of the plurality of batteries 40 included in the battery module 20 when the open end 12b is viewed in plan view. For example, as shown in FIG. 6, the contact portion P3 is disposed at a position on a center line AX3 connecting a center portion of the inner surface S5 and a center portion of the inner surface S6 when the open end 12b is viewed in plan view. For example, as shown in FIG. 6, the contact portion P3 is disposed at a position on the center line AX3 of the battery module 20. In addition, for example, as shown in FIG. 6, the contact portion P3 is disposed at a center portion (the position on the center line AX2) of the battery module 20 in the longitudinal direction of the battery module 20 when the open end 12b is viewed in plan view. For example, the contact portion P3 is disposed on the center portion (the position on the center line AX2) of the outer surface S3 of the battery module 20 when the open end 12b is viewed in plan view. For example, as shown in FIG. 6, the center line AX3 and the center line AX2 may coincide with each other.

The center portion of the inner surface S5 when the open end 12b is viewed in plan view is located at a position equidistant from both ends of the inner surface S5 when the open end 12b is viewed in plan view. The center portion of the inner surface S6 when the open end 12b is viewed in plan view is located at a position equidistant from both ends of the inner surface S6 when the open end 12b is viewed in plan view. The center portion of the battery module 20 in the longitudinal direction of the battery module 20 when the open end 12b is viewed in plan view is located at a position equidistant from both ends of the battery module 20 in the longitudinal direction of the battery module 20 when the open end 12b is viewed in plan view.

The contact portion P4 between the inner surface S6 and the outer surface S4 is disposed in a central region R4 of the inner surface S6 excluding both ends of the inner surface S6 when the open end 12b is viewed in plan view. For example, as shown in FIG. 6, the central region R4 is a region facing the center battery 40 in the arrangement direction of the battery 40 and the two batteries 40 (that is, a total of three batteries 40) on both sides of the center battery 40 of the plurality of batteries 40 included in the battery module 20 when the open end 12b is viewed in plan view. For example, as shown in FIG. 6, the contact portion P4 is disposed at a portion on the center line AX3 of the battery module 20 when the open end 12b is viewed in plan view. In addition, for example, as shown in FIG. 6, the contact portion P4 is disposed at the center portion (the position on the center line AX2) in the longitudinal direction of the battery module 20 when the open end 12b is viewed in plan view. For example, the contact portion P4 is disposed on the center portion (the position on the center line AX2) of the outer surface S4 of the battery module 20 when the open end 12b is viewed in plan view.

For example, as shown in FIG. 7, a vertex T1 of the inner surface S1 is provided in the central region R1 when the battery module 20 is removed from the lower case 10a. The vertex T1 of the inner surface S1 is provided, for example, at a position on the center line AX1 of the open end 12a. For example, as shown in FIG. 7, a vertex T2 of the inner surface S2 is provided in the central region R2 when the battery module 20 is removed from the lower case 10a. The vertex T2 of the inner surface S2 is provided, for example, at a position on the center line AX1 of the open end 12a. When the battery module 20 is removed from the lower case 10a, the vertexes T1 and T2 may be provided at positions on the center line AX1 of the open end 12a, and a distance between the vertex T1 and the vertex T2 may be the shortest distance between the inner surface S1 and the inner surface S2.

The vertex T1 of the inner surface S1 may correspond to, for example, the contact portion P1 described above. The vertex T2 of the inner surface S2 may correspond to, for example, the contact portion P2 described above. In these cases, the vertexes T1 and T2 may be provided at positions on the center line AX1 of the open end 12a, the vertex T1 may be in contact with a position on the center line AX2 of the outer surface S3, and the vertex T2 may be in contact with a position on the center line AX2 of the outer surface S4.

For example, as shown in FIG. 8, a vertex T3 of the inner surface S5 is provided in the central region R3 when the battery module 20 is removed from the upper case 10b. The vertex T3 of the inner surface S5 is provided, for example, at a position on the center line AX3 of the open end 12b. For example, as shown in FIG. 8, a vertex T4 of the inner surface S6 is provided in the central region R4 when the battery module 20 is removed from the upper case 10b. The vertex T4 of the inner surface S6 is provided, for example, at a position on the center line AX3 of the open end 12b. When the battery module 20 is removed from the upper case 10b, the vertexes T3 and T4 may be provided at positions on the center line AX3 of the open end 12b, and a distance between the vertex T3 and the vertex T4 may be the shortest distance between the inner surface S5 and the inner surface S6.

The vertex T3 of the inner surface S5 may correspond to, for example, the contact portion P3 described above. The vertex T4 of the inner surface S6 may correspond to, for example, the contact portion P4 described above. In these cases, the vertexes T3 and T4 may be provided at positions on the center line AX3 of the open end 12b, the vertex T3 may be in contact with a position on the center line AX2 of the outer surface S4, and the vertex T4 may be in contact with a position on the center line AX2 of the outer surface S4.

For example, as shown in FIG. 9, the gap G1 is wider in the vicinity of an inner bottom surface S7 of the lower case 10a than in the vicinity of the open end 12a. This is because, in the inner surface S1, there is no warpage in the vicinity of the inner bottom surface S7 of the lower case 10a, and the contact portion P1 does not exist. As a result, the outer surface S3 spaces apart from the lower case 10a (inner surface S1) in the vicinity of the inner bottom surface S7 of the lower case 10a, and does not have the contact portion (contact portion P1) with the inner surface S1. For example, as shown in FIG. 9, the gap G2 is wider in the vicinity of the inner bottom surface S7 of the lower case 10a than in the vicinity of the open end 12a. This is because, in the inner surface S2, there is no warpage in the vicinity of the inner bottom surface S7 of the lower case 10a, and the contact portion P2 does not exist. As a result, the outer surface S4 spaces apart from the lower case 10a (inner surface S2) in the vicinity of the inner bottom surface S7 of the lower case 10a, and does not have the contact portion (contact portion P2) with the inner surface S2.

For example, as shown in FIG. 10, the gap G3 is wider in the vicinity of the inner top surface S8 of the upper case 10b than in the vicinity of the open end 12b. This is because, in the inner surface S5, there is no warpage in the vicinity of the inner top surface S8 of the upper case 10b, and the contact portion P3 does not exist. As a result, the outer surface S3 spaces apart from the upper case 10b (inner surface S5) in the vicinity of the inner top surface S8 of the upper case 10b, and does not have the contact portion (contact portion P3) with the inner surface S5. For example, as shown in FIG. 10, the gap G4 is wider in the vicinity of the inner top surface S8 of the upper case 10b than in the vicinity of the open end 12b. This is because, in the inner surface S6, there is no warpage in the vicinity of the inner top surface S8 of the upper case 10b, and the contact portion P4 does not exist. As a result, the outer surface S4 spaces apart from the upper case 10b (inner surface S6) in the vicinity of the inner top surface S8 of the upper case 10b, and does not have the contact portion (contact portion P4) with the inner surface S6.

### [1-2. Function]

Next, functions of the battery pack 1, particularly the impact resistance, will be described. FIG. 13 is a view for explaining a function of the exterior case 10 when the battery pack 1 falls on a ground 100.

It is assumed that the battery pack 1 falls and collides with the ground 100, and a large impact is applied to the exterior case 10 of the battery pack 1. At this time, for example, as shown in FIGS. 5 and 6, the battery module 20 in the battery pack 1 is supported (sandwiched) by the warpage of the inner surfaces S1 and S2 provided in the exterior case 10, and is supported (sandwiched) by the warpage of the inner surfaces S5 and S6. In addition, the gaps G1, G2, G3, and G4 are provided between the battery module 20 and the exterior case 10. Thus, as shown in FIG. 13, for example, a large impact applied to the exterior case 10 is relaxed or absorbed by displacement of warpage (for example, warpage of the inner surfaces S2 and S6) of the inner surface close to the ground 100, and is not directly transferred to the battery module 20 in the battery pack 1. That is, warpage (for example, warpage of the inner surfaces S2 and S6) of the inner surface provided in the exterior case 10 functions as a cushioning material against an impact applied from the outside. As a result, the battery module 20 in the battery pack 1 is protected from an impact applied from the outside by the warpage (for example, warpage of the inner surfaces S2 and S6) of the inner surface provided in the exterior case 10.

Next, effects of the battery pack 1 will be described according to an embodiment.

In the present embodiment, the battery module 20 is supported by the inner surfaces S1, S2, S5, and S6 by warpage of the inner surfaces S1, S2, S5, and S6 provided in the exterior case 10. As a result, when a large impact such as falling is applied to the battery pack 1, the impact is alleviated or absorbed by warpage of the inner surfaces S1, S2, S5, and S6. As a result, the battery module 20 can be protected from the impact. By the way, in the battery pack 1, a large impact such as falling is alleviated or absorbed by warpage of the inner surfaces S1, S2, S5, and S6. As described above, in the battery pack 1, instead of providing a new component, the inner surfaces S1, S2, S5, and S6 of the existing exterior case 10 have a function of alleviating or absorbing buffer. In addition, the inner surface of the existing exterior case 10 is just warped, and a complicated structure is not provided. Therefore, impact resistance can be improved without complicating the structure.

In the present embodiment, the inner surface S1 and the outer surface S3 are in contact with each other due to warpage of the inner surface S1, and the gap G1 in which the inner surface S1 and the outer surface S3 space away from each other is formed around the contact portion P1 between the inner surface S1 and the outer surface S3. The inner surface S2 and the outer surface S4 are in contact with each other due to warpage of the inner surface S2, and the gap G2 in which the inner surface S2 and the outer surface S4 space away from each other is formed around the contact portion P2 between the inner surface S2 and the outer surface S4. The inner surface S5 and the outer surface S3 are in contact with each other due to warpage of the inner surface S5, and the gap G3 in which the inner surface S5 and the outer surface S3 space away from each other is formed around the contact portion P3 between the inner surface S5 and the outer surface S3. The inner surface S6 and the outer surface S4 are in contact with each other due to warpage of the inner surface S6, and the gap G4 in which the inner surface S5 and the outer surface S4 space away from each other is formed around the contact portion P4 between the inner surface S6 and the outer surface S4.

AS a result, as shown in FIG. 13, for example, a large impact applied to the exterior case 10 is relaxed or absorbed by displacement of warpage (for example, warpage of the inner surfaces S2 and S6) of the inner surface close to the ground 100, and is not directly transferred to the battery module 20 in the battery pack 1. That is, warpage (for example, warpage of the inner surfaces S2 and S6) of the inner surface provided in the exterior case 10 functions as a cushioning material against an impact applied from the outside. As a result, the battery module 20 in the battery pack 1 can be protected from an impact applied from the outside by the warpage (for example, warpage of the inner surfaces S2 and S6) of the inner surface provided in the exterior case 10.

In the present embodiment, in the inner surfaces S1, S2, S5, and S6, a portion warped inward of the exterior case 10 is formed in a portion including the open ends 12a and 12b. As a result, an amount of warpage of the inner surfaces S1, S2, S5, and S6 can be increased, so that the battery module 20 in the battery pack 1 can be protected from a large external impact.

In the present embodiment, the contact portion P1 between the inner surface S1 and the outer surface S3 is disposed in the central region R1 of the inner surface S1 excluding both ends of the inner surface S1 when the open end 12a is viewed in plan view. The contact portion P2 between the inner surface S2 and the outer surface S4 is disposed in a central region R2 of the inner surface S2 excluding both ends of the inner surface S2 when the open end 12a is viewed in plan view. The contact portion P3 between the inner surface S5 and the outer surface S3 is disposed in a central region R3 of the inner surface S5 excluding both ends of the inner surface S5 when the open end 12b is viewed in plan view. The contact portion P4 between the inner surface S6 and the outer surface S4 is disposed in a central region R4 of the inner surface S6 excluding both ends of the inner surface S6 when the open end 12b is viewed in plan view. As a result, an amount of warpage of the inner surfaces S1, S2, S5, and S6 can be increased, so that the battery module 20 in the battery pack 1 can be protected from a large external impact.

In the present embodiment, when the open end 12a is viewed in plan view with the battery module 20 removed from the lower case 10a, the vertex T1 of the inner surface S1 and the vertex T2 of the inner surface S2 are provided at positions on the center line AX1 of the open end 12a. In addition, when the open end 12b is viewed in plan view with the battery module 20 removed from the upper case 10b, the vertex T3 of the inner surface S5 and the vertex T4 of the inner surface S6 are provided at positions on the center line AX3 of the open end 12b. As a result, an amount of warpage of the inner surfaces S1, S2, S5, and S6 can be increased, so that the battery module 20 in the battery pack 1 can be protected from a large external impact.

In the present embodiment, when the open end 12a is viewed in plan view, the vertex T1 of the inner surface S1 and the vertex T3 of the inner surface S5 are in contact with a center portion (the position on the center line AX2) of the outer surface S3. In addition, when the open end 12b is viewed in plan view, the vertex T2 of the inner surface S2 and the vertex T4 of the inner surface S6 are in contact with a center portion (the position on the center line AX2) of the outer surface S4. As a result, the amount of warpage of the inner surfaces S1, S2, S5, and S6 can be increased, and, in addition, the battery module 20 can be supported in a well-balanced manner by the inner surfaces S1, S2, S5, and S6. As a result, the battery module 20 in the battery pack 1 can be protected from a large impact from the outside.

In the present embodiment, the outer surface S3 spaces apart from the lower case 10a (the inner surface S1) in the vicinity of the inner bottom surface S7 of the lower case 10a, and spaces apart from the upper case 10b (the inner surface S5) in the vicinity of the inner top surface S8 of the upper case 10b. The outer surface S4 spaces apart from the lower case 10a (the inner surface S2) in the vicinity of the inner bottom surface S7 of the lower case 10a, and spaces apart from the upper case 10b (the inner surface S6) in the vicinity of the inner top surface S8 of the upper case 10b. Here, in the vicinity of the inner bottom surface S7 of the lower case 10a on the inner surface S1, in the vicinity of the inner bottom surface S7 of the upper case 10b on the inner surface S2, in the vicinity of the inner top surface S8 of the upper case 10b on the inner surface S5, and in the vicinity of the inner top surface S8 of the upper case 10b on the inner surface S6, there is almost no warpage, and there is almost no function of alleviating or absorbing buffer. However, as described above, the outer surfaces S3 and S4 space apart from these portions, and do not receive an impact directly from these portions. As a result, the battery module 20 in the battery pack 1 can be protected from a large impact from the outside.

In the present embodiment, the inner surfaces S1 and S2 are arranged so as to sandwich the plurality of batteries 40 from the longitudinal direction of the battery 40. This makes it possible to protect the positive electrode 41 and the negative electrode 42, which are vulnerable to impact in the battery 40.

Next, a modification of the battery pack 1 according to the above embodiment will be described.

In the above embodiment, the center line AX2 of the battery module 20 may be provided at a position different from the center line AX1, for example, as shown in FIGS. 14 and 15. FIG. 14 shows a modification of the sectional configuration example of FIG. 5. FIG. 15 shows a modification of the sectional configuration example of FIG. 6. Even in such a case, when the position of the center line AX2 is within the central region R1, the battery module 20 can be supported in a well-balanced manner by the inner surfaces S1, S2, S5, and S6. As a result, the battery module 20 in the battery pack 1 can be protected from a large impact from the outside.

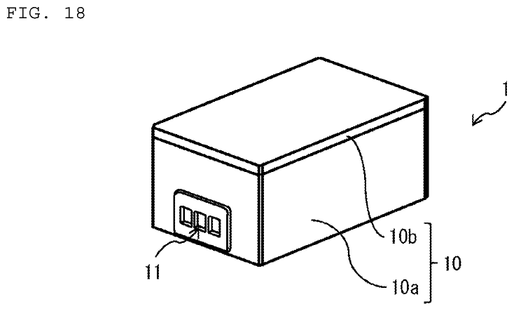

In the above embodiment and the modifications of the embodiment, for example, as shown in FIGS. 16 and 17, the inner surfaces Sa and Sb of the lower case 10a and the inner surfaces Sc and Sd of the upper case 10b may also be warped. FIG. 16 shows a modification of the sectional configuration example of FIG. 5. FIG. 17 shows a modification of the sectional configuration example of FIG. 6. The inner surfaces Sa and Sc are provided at positions facing the outer surface S12 of the battery module 20. The inner surfaces Sb and Sd are provided at positions facing the outer surface S11 of the battery module 20. The outer surfaces S11 and S12 are arranged so as to sandwich the plurality of batteries 40 from the arrangement direction of the battery 40.

In this case, when the battery pack 1 falls from the inner surface Sa side of the lower case 10a and the inner surface Sc side of the upper case 10b, or falls from the inner surface Sb side of the lower case 10a and the inner surface Sd side of the upper case 10b, the battery module 20 in the battery pack 1 can be protected.

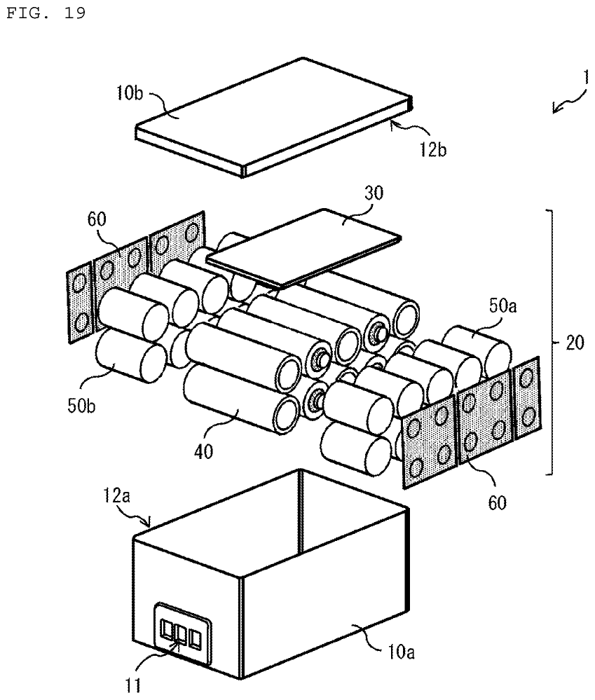

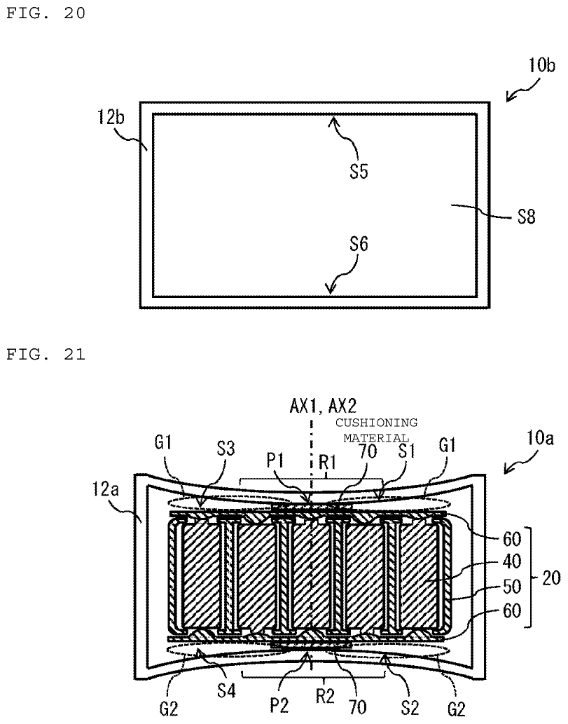

In the above embodiment and the modifications of the embodiment, the upper case 10b may have a lid shape, for example, as shown in FIGS. 18, 19, and 20. FIG. 18 shows a modification of the perspective configuration of the battery pack 1. FIG. 19 shows a developed perspective configuration example of the battery pack 1 of FIG. 18. FIG. 20 shows a planar configuration example of the inner top surface S8 side of the upper case 10b of FIG. 19.

In the present modification, the housing space for housing the battery module 20 is formed by the space surrounded by the lower case 10a, and the upper case 10b has a role of sealing the housing space from an external space. At this time, the inner surfaces S5 and S6 of the upper case 10b are not warped as shown in the above embodiment, for example, as shown in FIG. 20.

In the present modification, the battery module 20 is supported by the inner surfaces S1 and S2 by warpage of the inner surfaces S1 and S2 provided in the exterior case 10. As a result, when a large impact such as falling is applied to the battery pack 1, the impact is alleviated or absorbed by warpage of the inner surfaces S1 and S2. As a result, the battery module 20 can be protected from the impact. By the way, in the battery pack 1, a large impact such as falling is alleviated or absorbed by warpage of the inner surfaces S1 and S2. As described above, in the battery pack 1, instead of providing a new component, the inner surfaces S1 and S2 of the existing exterior case 10 have a function of alleviating or absorbing buffer. In addition, the inner surface of the existing exterior case 10 is just warped, and a complicated structure is not provided. Therefore, impact resistance can be improved without complicating the structure.

In the modification, the contact portion P1 between the inner surface S1 and the outer surface S3 is disposed in the central region R1 of the inner surface S1 excluding both ends of the inner surface S1 when the open end 12a is viewed in plan view. The contact portion P2 between the inner surface S2 and the outer surface S4 is disposed in a central region R2 of the inner surface S2 excluding both ends of the inner surface S2 when the open end 12a is viewed in plan view. As a result, the amount of warpage of the inner surfaces S1 and S2, can be increased, so that the battery module 20 in the battery pack 1 can be protected from a large external impact.

In the present modification, when the open end 12a is viewed in plan view with the battery module 20 removed from the lower case 10a, the vertex T1 of the inner surface S1 and the vertex T2 of the inner surface S2 are provided at positions on the center line AX1 of the open end 12a. As a result, the amount of warpage of the inner surfaces S1 and S2, can be increased, so that the battery module 20 in the battery pack 1 can be protected from a large external impact.

In the present modification, when the open end 12a is viewed in plan view, the vertex T1 of the inner surface S1 is in contact with the center portion (the position on the center line AX2) of the outer surface S3. In addition, when the open end 12b is viewed in plan view, the vertex T2 of the inner surface S2 is in contact with the center portion (the position on the center line AX2) of the outer surface S4. As a result, the amount of warpage of the inner surfaces S1 and S2 can be increased, and, in addition, the battery module 20 can be supported in a well-balanced manner by the inner surfaces S1 and S2. As a result, the battery module 20 in the battery pack 1 can be protected from a large impact from the outside.

In the above embodiment and the modifications of the embodiment, for example, as shown in FIG. 21, the battery pack 1 may include a cushioning material 70. The cushioning material 70 includes, for example, a cushion material such as sponge. For example, as shown in FIG. 21, the cushioning material 70 is disposed between the outer surface S3 and the inner surface S1, and is disposed between the outer surface S4 and the inner surface S2. The cushioning material 70 is provided, for example, to prevent reduction in reliability due to dimensional variations of the exterior case 10 and the battery module 20. Even in such a case, the battery module 20 is held (sandwiched) by at least the inner surfaces S1 and S2 among the inner surfaces S1, S2, S3, and S4 via the cushioning material 70 due to warpage of at least the inner surfaces S1 and S2 among the inner surfaces S1, S2, S3, and S4, similarly to the above embodiment.

As a result, when a large impact such as falling is applied to the battery pack 1, the impact is alleviated or absorbed by warpage of at least the inner surfaces S1 and S2 among the inner surfaces S1, S2, S3, and S4. As a result, the battery module 20 can be protected from the impact. By the way, in the battery pack 1, a large impact such as falling is alleviated or absorbed by warpage of at least the inner surfaces S1 and S2 among the inner surfaces S1, S2, S3, and S4. As described above, in the battery pack 1, instead of providing a new component, at least the inner surfaces S1 and S2 among the inner surfaces S1, S2, S3, and S4 of the existing exterior case 10 have a function of alleviating or absorbing buffer. In addition, the inner surface of the existing exterior case 10 is just warped, and a complicated structure is not provided. Therefore, impact resistance can be improved without complicating the structure.

The present technology has been described above with reference to the plurality of embodiments and the modifications of the embodiments; however, the present technology is not limited to the aspects described in the above embodiments and the like, and various modifications may be made to the present technology.

Specifically, the case where the battery structure of the secondary battery is columnar (cylindrical) has been described; however, the battery structure of the secondary battery applied to the battery pack of the present technology is not particularly limited. Specifically, the battery structure of the secondary battery may be a rectangular type, a coin type, or the like. The secondary battery may have a wound structure, or may have another structure such as a laminated structure.

Further, lithium has been used as an electrode reactant of the secondary battery, but the kind of the electrode reactant is not particularly limited. Specifically, the electrode reactant may be another element of Group 1 in the long-periodic table such as sodium or potassium, an element of Group 2 in the long-periodic table such as magnesium or calcium or another light metal such as aluminum.

Since the effects described in the present specification are merely examples, the effects of the present technology are not limited to the effects described in the present specification. Therefore, other effects regarding the present technology may be obtained.

The present technology may also take the following configurations according to an embodiment.

<1>

A battery pack including:
a battery module including a battery and a battery holder that holds the battery; and
an exterior case that houses the battery module,
wherein
the battery module includes
   a first outer surface, and
   a second outer surface facing the first outer surface,
the exterior case includes
   a first inner surface disposed facing the first outer surface and warped toward the first outer surface, and
   a second inner surface disposed facing the second outer surface and warped toward the second outer surface, and
the battery module is sandwiched between the first inner surface and the second inner surface by warpage of the first inner surface and warpage of the second inner surface.
   <2>

A battery pack including:
a battery module including a battery and a battery holder that holds the battery; and
an exterior case that houses the battery module,
wherein
the battery module includes
   a first outer surface, and
   a second outer surface facing the first outer surface,
the exterior case includes
   a first inner surface pressed against and in contact with the first outer surface, and
   a second inner surface pressed against and in contact with the second outer surface,
a contact portion between the first outer surface and the first inner surface is surrounded by a first gap where the first outer surface and the first inner surface space apart from each other, and
a contact portion between the second outer surface and the second inner surface is surrounded by a second gap where the second outer surface and the second inner surface space apart from each other.
   <3>

The battery pack according to <1> or <2>, wherein
the exterior case includes
   a first case having a first open end, and
   a second case having a second open end,
the first case and the second case have a shape that can form a housing space of the battery module surrounded by the first case and the second case by butt-joining the first open end and the second open end against each other,
the battery module is disposed in the housing space,
the first inner surface includes
   a third inner surface formed in a portion of an inner surface of the first case, the portion including a part of the first open end, the third inner surface being warped toward the first outer surface, and
   a fourth inner surface formed in a portion of an inner surface of the second case, the portion including a part of the second open end, the fourth inner surface being warped toward the first outer surface, and
the second inner surface includes
   a fifth inner surface formed in a portion of an inner surface of the first case, the portion including a part of the first open end, the fifth inner surface being warped toward the second outer surface, and
   a sixth inner surface formed in a portion of an inner surface of the second case, the portion including a part of the second open end, the sixth inner surface being warped toward the second outer surface.
      <4>

The battery pack according to <3>, wherein
a first contact portion between the third inner surface and the first outer surface is disposed in a first central region of the third inner surface excluding both ends of the third inner surface when the first open end is viewed in plan view,
a second contact portion between the fourth inner surface and the first outer surface is disposed in a second central region of the fourth inner surface excluding both ends of the fourth inner surface when the second open end is viewed in plan view,
a third contact portion between the fifth inner surface and the second outer surface is disposed in a third central region of the fifth inner surface excluding both ends of the fifth inner surface when the first open end is viewed in plan view, and
a fourth contact portion between the sixth inner surface and the second outer surface is disposed in a fourth central region of the sixth inner surface excluding both ends of the sixth inner surface when the second open end is viewed in plan view.
   <5>

The battery pack according to <3> or <4>, wherein
a vertex of the third inner surface and a vertex of the fifth inner surface are provided on a center line of the first open end when the first open end is viewed in plan view in a state where the battery module is removed from the exterior case, and
a vertex of the fourth inner surface and a vertex of the sixth inner surface are provided on a center line of the second open end when the second open end is viewed in plan view in the state where the battery module is removed from the exterior case.
   <6>

The battery pack according to <5>, wherein
when the first open end is viewed in plan view, the vertex of the third inner surface and the vertex of the fourth inner surface are in contact with a central portion of the first outer surface, and
when the second open end is viewed in plan view, the vertex of the fifth inner surface and the vertex of the sixth inner surface are in contact with a central portion of the second outer surface.
   <7>

The battery pack according to <1>, wherein
the exterior case includes
   a first case having a first open end, and
   a second case having a second open end,
the first case and the second case have a shape that can form a housing space of the battery module surrounded by the first case and the second case by butt-joining the first open end and the second open end against each other,
the battery module is disposed in the housing space, and
each of the first inner surface and the second inner surface is formed in a portion of the first case including a part of the first open end, and is not formed in the second case.
   <8>

The battery pack according to <7>, wherein
a first contact portion of the first inner surface, the first contact portion being in contact with the first outer surface, is disposed in a first central region of the first inner surface excluding both ends of the first inner surface when the first open end is viewed in plan view, and
a second contact portion of the second inner surface, the second contact portion being in contact with the second outer surface, is disposed in a second central region of the second inner surface excluding both ends of the second inner surface when the first open end is viewed in plan view.
   <9>

The battery pack according to <8>, wherein
a vertex of the first inner surface is provided on a center line of the first open end when the first open end is viewed in plan view in a state where the battery module is removed from the exterior case, and
a vertex of the second inner surface is provided on a center line of the second open end when the second open end is viewed in plan view in the state where the battery module is removed from the exterior case.
   <10>

The battery pack according to <9>, wherein
when the first open end is viewed in plan view, the vertex of the first inner surface is in contact with a central portion of the first outer surface, and
when the second open end is viewed in plan view, the vertex of the second inner surface is in contact with a central portion of the second outer surface.
   <11>

The battery pack according to any one of <1> to <10>, wherein
the first outer surface spaces apart from the first inner surface in a vicinity of an inner bottom surface and a vicinity of an inner top surface of the exterior case, and does not have a contact portion with the first inner surface, and
the second outer surface spaces apart from the second inner surface in a vicinity of the inner bottom surface and a vicinity of the inner top surface of the exterior case, and does not have a contact portion with the second inner surface.
   <12>

The battery pack according to any one of <1> to <11>, wherein
the battery has a columnar shape,
the battery module includes a plurality of the batteries arranged side by side in a two-dimensional direction orthogonal to a longitudinal direction of the battery, and
the first inner surface and the second inner surface are arranged so as to sandwich the plurality of batteries from the longitudinal direction of the battery.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A battery pack comprising:
a battery module including a battery and a battery holder that holds the battery; and
an exterior case that houses the battery module,
wherein
the battery module includes
a first outer surface, and
a second outer surface facing the first outer surface,
the exterior case includes
a first inner surface disposed facing the first outer surface and warped toward the first outer surface, and
a second inner surface disposed facing the second outer surface and warped toward the second outer surface, and
the battery module is sandwiched between the first inner surface and the second inner surface by warpage of the first inner surface and warpage of the second inner surface.

2. A battery pack comprising:
a battery module including a battery and a battery holder that holds the battery; and
an exterior case that houses the battery module,
wherein
the battery module includes
a first outer surface, and
a second outer surface facing the first outer surface,
the exterior case includes
a first inner surface pressed against and in contact with the first outer surface, and
a second inner surface pressed against and in contact with the second outer surface,
a contact portion between the first outer surface and the first inner surface is surrounded by a first gap where the first outer surface and the first inner surface space apart from each other, and
a contact portion between the second outer surface and the second inner surface is surrounded by a second gap where the second outer surface and the second inner surface space apart from each other.

3. The battery pack according to claim 1, wherein
the exterior case includes
a first case having a first open end, and
a second case having a second open end,
the first case and the second case have a shape that can form a housing space of the battery module surrounded by the first case and the second case by butt-joining the first open end and the second open end against each other,
the battery module is disposed in the housing space,
the first inner surface includes
a third inner surface formed in a portion of an inner surface of the first case, the portion including a part of the first open end, the third inner surface being warped toward the first outer surface, and
a fourth inner surface formed in a portion of an inner surface of the second case, the portion including a part of the second open end, the fourth inner surface being warped toward the first outer surface, and
the second inner surface includes
a fifth inner surface formed in a portion of an inner surface of the first case, the portion including a part of the first open end, the fifth inner surface being warped toward the second outer surface, and
a sixth inner surface formed in a portion of an inner surface of the second case, the portion including a part of the second open end, the sixth inner surface being warped toward the second outer surface.

4. The battery pack according to claim 3, wherein
a first contact portion between the third inner surface and the first outer surface is disposed in a first central region of the third inner surface excluding both ends of the third inner surface when the first open end is viewed in plan view,
a second contact portion between the fourth inner surface and the first outer surface is disposed in a second central region of the fourth inner surface excluding both ends of the fourth inner surface when the second open end is viewed in plan view,
a third contact portion between the fifth inner surface and the second outer surface is disposed in a third central region of the fifth inner surface excluding both ends of the fifth inner surface when the first open end is viewed in plan view, and
a fourth contact portion between the sixth inner surface and the second outer surface is disposed in a fourth central region of the sixth inner surface excluding both ends of the sixth inner surface when the second open end is viewed in plan view.

5. The battery pack according to claim 3, wherein
a vertex of the third inner surface and a vertex of the fifth inner surface are provided on a center line of the first open end when the first open end is viewed in plan view in a state where the battery module is removed from the exterior case, and
a vertex of the fourth inner surface and a vertex of the sixth inner surface are provided on a center line of the second open end when the second open end is viewed in plan view in the state where the battery module is removed from the exterior case.

6. The battery pack according to claim 5, wherein
when the first open end is viewed in plan view, the vertex of the third inner surface and the vertex of the fourth inner surface are in contact with a central portion of the first outer surface, and
when the second open end is viewed in plan view, the vertex of the fifth inner surface and the vertex of the sixth inner surface are in contact with a central portion of the second outer surface.

7. The battery pack according to claim 1, wherein
the exterior case includes
a first case having a first open end, and
a second case having a second open end,
the first case and the second case have a shape that can form a housing space of the battery module surrounded by the first case and the second case by butt-joining the first open end and the second open end against each other, the battery module is disposed in the housing space, and
each of the first inner surface and the second inner surface is formed in a portion of the first case including a part of the first open end, and is not formed in the second case.

8. The battery pack according to claim 7, wherein
a first contact portion of the first inner surface, the first contact portion being in contact with the first outer surface, is disposed in a first central region of the first inner surface excluding both ends of the first inner surface when the first open end is viewed in plan view, and
a second contact portion of the second inner surface, the second contact portion being in contact with the second outer surface, is disposed in a second central region of the second inner surface excluding both ends of the second inner surface when the first open end is viewed in plan view.

9. The battery pack according to claim 8, wherein
a vertex of the first inner surface is provided on a center line of the first open end when the first open end is viewed in plan view in a state where the battery module is removed from the exterior case, and
a vertex of the second inner surface is provided on a center line of the second open end when the second open end is viewed in plan view in the state where the battery module is removed from the exterior case.

10. The battery pack according to claim 9, wherein
when the first open end is viewed in plan view, the vertex of the first inner surface is in contact with a central portion of the first outer surface, and
when the second open end is viewed in plan view, the vertex of the second inner surface is in contact with a central portion of the second outer surface.

11. The battery pack according to claim 1, wherein
the first outer surface spaces apart from the first inner surface in a vicinity of an inner bottom surface and a vicinity of an inner top surface of the exterior case, and does not have a contact portion with the first inner surface, and
the second outer surface spaces apart from the second inner surface in a vicinity of the inner bottom surface and a vicinity of the inner top surface of the exterior case, and does not have a contact portion with the second inner surface.

12. The battery pack according to claim 1, wherein
the battery has a columnar shape,
the battery module includes a plurality of the batteries arranged side by side in a two-dimensional direction orthogonal to a longitudinal direction of the battery, and
the first inner surface and the second inner surface are arranged so as to sandwich the plurality of batteries from the longitudinal direction of the battery.
